(19) United States
(12) Patent Application Publication
(10) Pub. No.: US 2013/0179365 A1
(43) Pub. Date: Jul. 11, 2013

(54) SYSTEMS AND METHODS OF RAPID BUSINESS DISCOVERY AND TRANSFORMATION OF BUSINESS PROCESSES

(71) Applicants: Sofia Passova, Richmond Hill (CA); Alexander Ladizginsky, Toronto (CA); Stanislav Passov, Richmond Hill (CA)

(72) Inventors: Sofia Passova, Richmond Hill (CA); Alexander Ladizginsky, Toronto (CA); Stanislav Passov, Richmond Hill (CA)

(73) Assignee: STEREOLOGIC LTD., Toronto, ON (CA)

(21) Appl. No.: 13/811,935

(22) PCT Filed: Jul. 28, 2011
(86) PCT No.: PCT/CA11/50468

§ 371 Date: Mar. 25, 2013

Related U.S. Application Data
(60) Provisional application No. 61/368,427, filed on Jul. 28, 2010.

(51) Int. Cl. G06Q 10/06

(52) U.S. Cl. CPC G06Q 10/067
USPC 705/348

(57) ABSTRACT

A system and method for business process modelling including: an image capturing module, configured to capture screenshots of the business process; an image repository, configured to store the captured screenshots; and a mapping module, configured to map the captured screenshots to objects and to connect the objects to model a business process. In a particular case, the system and method may further include an image analysis module configured to analyse the captured screenshots for significant events and wherein the significant events and associated screenshots are mapped to the objects.

### RELATED APPLICATIONS

This patent application claims priority to U.S. Provisional Patent Application 61/368,427 filed Jul. 28, 2010, which is hereby incorporated herein by reference.

### FIELD

The present document relates generally to systems and methods for business process modeling. In particular, the present document relates to systems and methods of rapid business discovery and transformation of business processes.

### BACKGROUND

Business processes can be complex and difficult to model or detail. Frequently, companies do not have a clear picture of their business processes. The processes are often hidden in volumes of documentation, legacy system and individual's minds. The legacy systems may be unfamiliar to new employees. Further, various legacy systems may be designed to operate on various platforms and require multiple individuals to complete certain business processes.

While IT stakeholders have repositories that allow them to manage IT data, typically the business users do not have any tools that allow them to discover and visualize actual business processes. Conventional business process mining methods allow for the discovery of system processes based on analysis of database logs for specific platforms. However, these conventional methods do not provide for the detection of what business users do with business applications, do not allow working in real time and require extensive post transactional manual analysis. This significantly slows down the business transformation and improvement processes.

It is therefore desirable to have methods and systems of rapid business discovery and transformation of business processes that are platform independent and easy to use for business user who do not have extensive experience with IT tools.

### SUMMARY

It is an object of the present disclosure to obviate or mitigate at least one disadvantage of previous systems and methods.

According to one aspect herein, there is provided a method for business process modelling of an at least partially computer implemented process, the method including: capturing screenshots of the business process; analyzing the screenshots to determine significant events; mapping the significant events to objects in a business process; and connecting the objects using business rules to model a business process.

In a particular case, the screenshots may be captured automatically at a predetermined time interval during the business process. In some cases and this case in particular, the screenshots may be assigned a timestamp to allow tracking of the time at which events occurred.

In another particular case, a plurality of screenshots are recorded and a subset of screenshots between significant events is mapped to the same object as at least one of the significant events.

In yet another particular case, at least one screenshot is analysed to generate data elements to be saved within a data dictionary. The data elements in the data dictionary may have defined data attributes based on required criteria and the data elements' physical representation. Further, business rules related to the data elements in the data dictionary may be presented as data attributes.

According to another aspect herein, there is provided a system for business process modelling including: an image capturing module, configured to capture screenshots of the business process; an image repository, configured to store the captured screenshots; and a mapping module, configured to map the captured screenshots to objects and to connect the objects to model a business process.

In a particular case, the system may further include an image analysis module configured to analyse the captured screenshots for significant events and wherein the significant events and associated screenshots are mapped to the objects.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 is an example of a mapped business process;

FIG. 2 is an example use case and alternative flow;

FIG. 3 is a rough fragment of a use case generated for the business process of FIG. 1;

FIG. 4 is a screen shot of a system implementing a proposed business process discovery method;

FIG. 5 illustrates an example data dictionary;

FIG. 6 illustrates a discovered activity being associated with a corresponding screen of a business application;

FIG. 7 illustrates label identification;

FIG. 8 illustrates data elements generation;

FIG. 9 illustrates a data dictionary with business rules;

FIG. 10 illustrates a business rule editor;

FIG. 11 illustrates business process discovery using screen capture;

FIG. 12 illustrates a possible implementation of rapid business process discovery;

FIG. 13 illustrates a flowchart of a method for platform independent business process discovery; and

FIG. 14 illustrates a flowchart of a method for Internet application discovery.

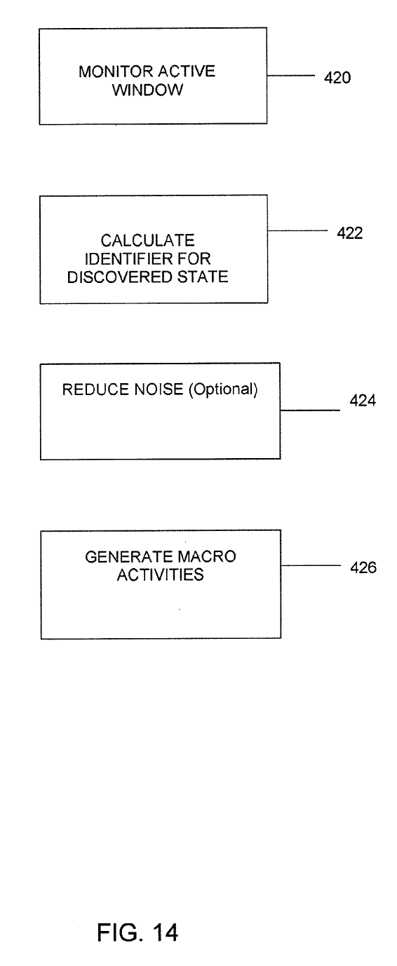

### DETAILED DESCRIPTION

It will be understood that the examples given are for illustration purposes only and that any specific limitations are indicated only for ease of understanding of the examples and may be modified as understood by one of skill in the art.

It will be understood that the systems and methods herein may be embodied in software or hardware or some combination of the two. Further, the software may comprise computer program instructions provided on a physical medium that when executed by a processor of a computing device cause the device to perform the method indicated by the software.

U.S. patent application Ser. No. 12/632,472, filed Dec. 7, 2009, by Passova et al., claiming priority to U.S. patent application Ser. No. 61/120,096, filed Dec. 5, 2008, and published on Jul. 8, 2010 as 2010-0174583, describes systems and methods for automated business process discovery based on user interaction with existing applications. The content of these applications is hereby incorporated by reference herein.

Generally this application provides systems and methods for rapid business discovery and transformation of business processes. While the noted embodiments lay a framework, additional information can be added with regard to other aspects of the systems and methods related to application modernization, Enterprise Resource Planning (ERP) projects, Business Process Transformation, Business Process Modeling (BPM), etc. In particular, it is useful to provide further detail on the creation of additional artefacts that are related to business process artefacts. For example, some additional artefacts for consideration are:
Use Cases
Data Dictionaries
Traceability between Use Cases and Data Dictionaries
Performance tracking/time stamps

Currently the creation of these artefacts, even for existing applications, is generally performed manually, which can be very complex and can be inaccurate.

In this disclosure, systems and methods for automated generation of Use Cases, Data Dictionaries, Traceability between them, and Performance tracking based on business processes reflecting the application behaviour are proposed.

Automated Use Case Generation based on Business Processes

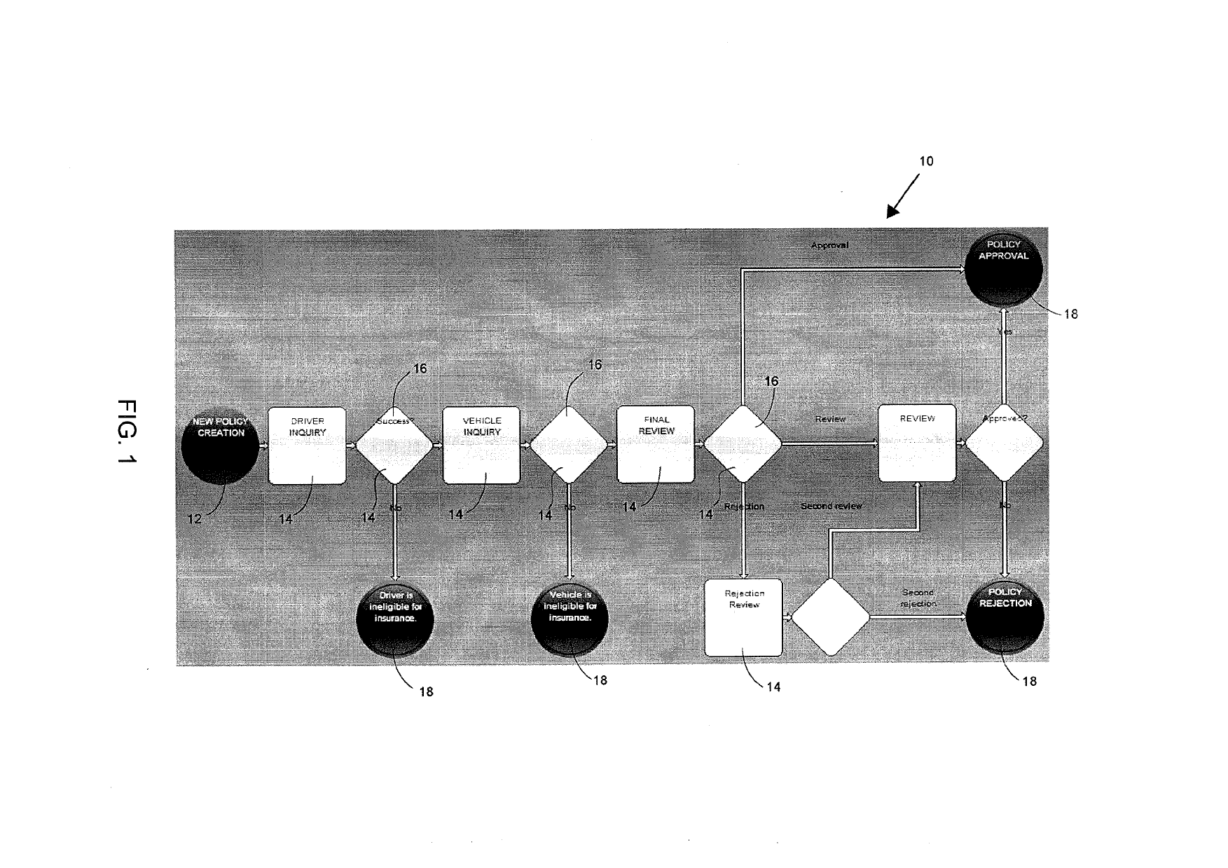

Business Processes are generally represented using a Business Process Modeling Notation (BPMN) specification or any similar structured format. An example of a Business Process 10 is provided in FIG. 1. A business process has a starting point 12 and a series of steps or activities 14. The steps may require for example, input of information or a decision to be made. The business process may include a plurality of forks 16, which may depend on the context and the decision made within the business process 10. The forks 16 may lead to various end points 18, or to further business process steps 14.

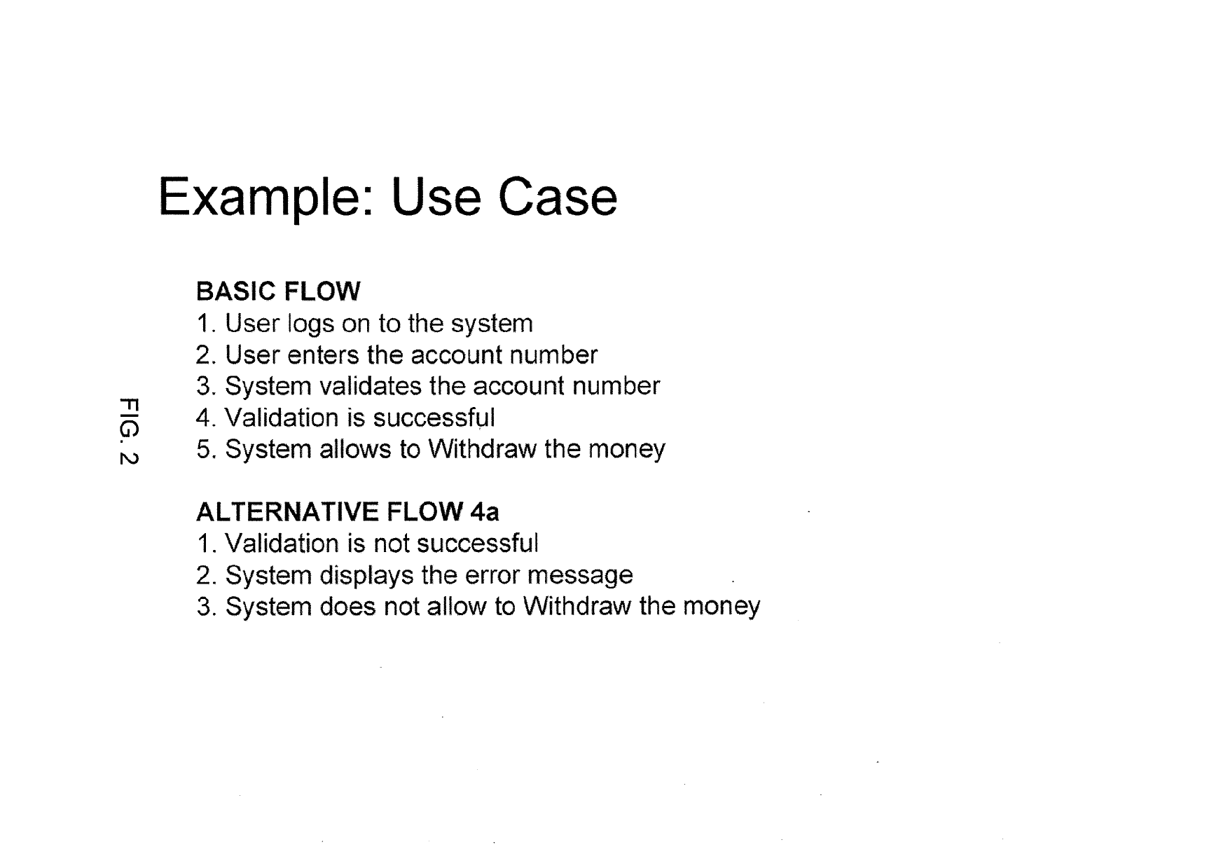

Use Cases are generally presented in a standard Unified Modelling Language (UML) format or any similar structured format. The UML format includes a set of interconnected flows with text instructions. Methods for numbering of steps and text representation may vary and are defined by the chosen Use Case Syntax (UML standard typically assumes flexible Use Case syntax). An example of a Use Case 20 is provided in FIG. 2. In this example, a user logs into a banking system 22 and enters an account number 24 or account information. The system validates the information 26. If the information is correct, the system then allows a user to withdraw money 28, or complete other banking information. If the information is incorrect the system may display an error message 30 as opposed to allowing a user to complete any banking tasks.

A method of developing a Use Case from a Business Process is generally outlined as:
Analyze the business process;
Define the “Control Points” that define a basic flow of the target Use Case;
Transform the flow defined by the Control Points into basic flow of the Use Case, methods of transformation are defined by required Use Case Syntax;
Detect all decisions (diamonds on the graphical representation) of the considered business process flow;
For each decision, define outgoing flows that do not belong to the basic flow and consider them as alternative flows;
Transform alternative flows into alternative flows of the target Use Case;
If a flow of the business process considered as alternative flow has Decisions with flows outgoing and not belonging to this flow, consider them as alternative sub-flows, similar to the alternative flows of the basic flow; and
Transform alternative sub-flows to alternative sub-flows of the target Use Case.

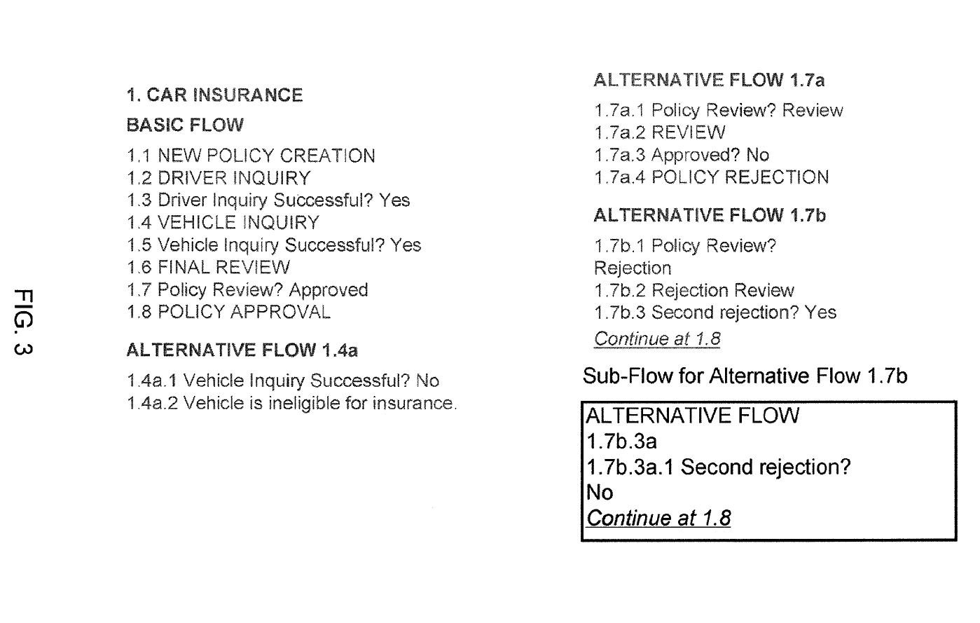

An example Use Case showing aspects for the Business Process presented in FIG. 1 is shown in FIG. 3.

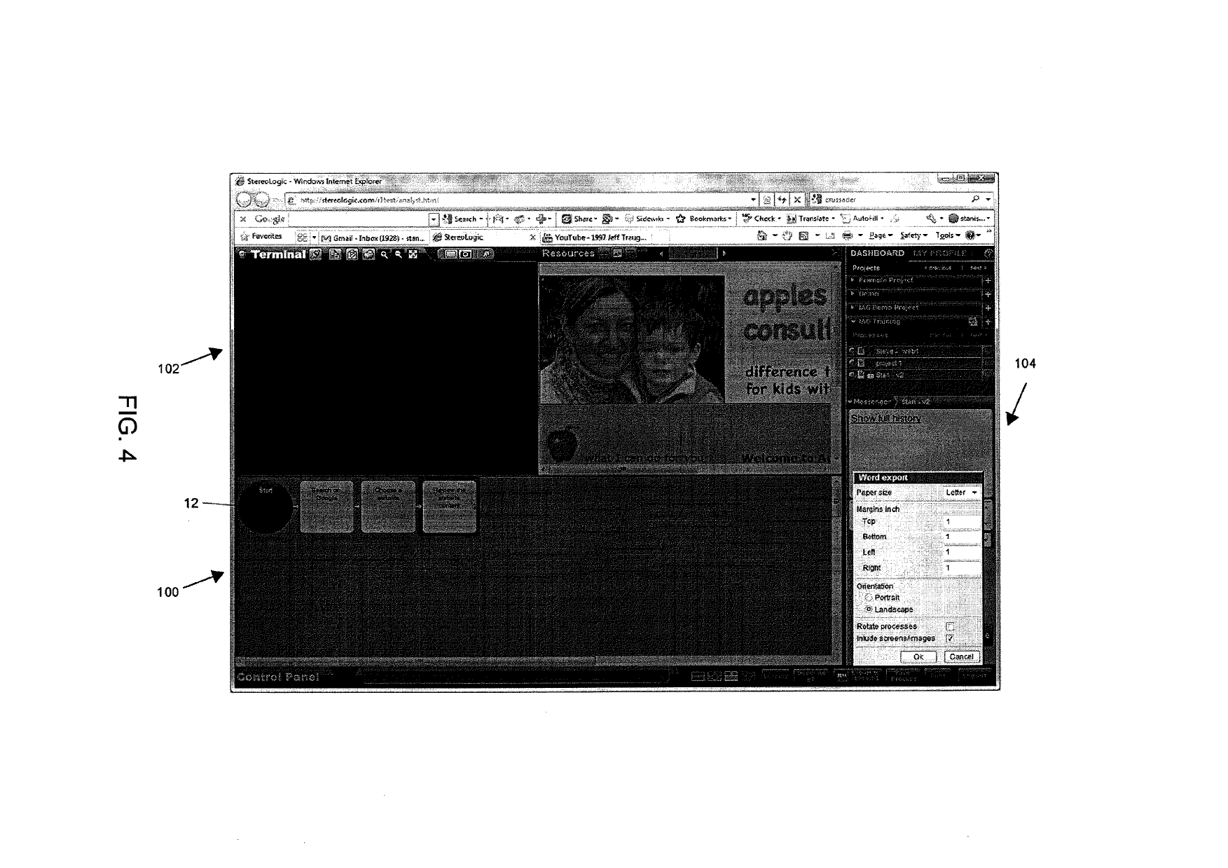

FIG. 4 illustrates a screenshot of an embodiment of a software program for a method of business process discovery. The business process flow 12 being developed may be shown in a business process screen 100, while user actions relating to the business process and use case may be shown in a terminal screen 102. The software program may also include export and editing components 104 to allow a user to modify, report and/or discuss the business process.

Automated Data Dictionary, Business Rule and Traceability generation based on Business Processes

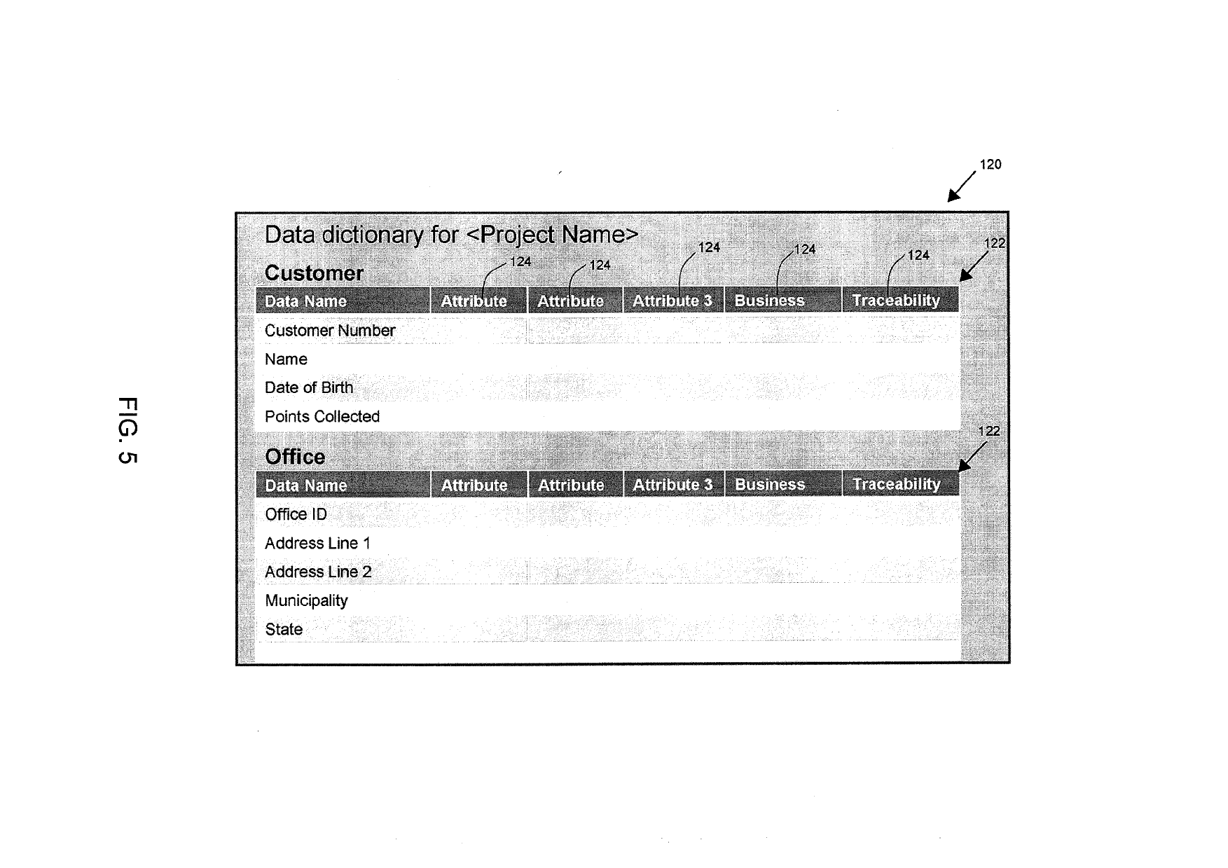

Data Dictionaries allow for the collection, analysis and classification of data with which processes work to accomplish a desired task. A Data Dictionary 120 is typically presented in the format as shown in FIG. 5. The Data Dictionary 120 may be a combination of tables 122 that may be further distinguished by attributes or other characteristics 124. The tables 122 or various characteristics may include associations with other tables or other fields within other tables. Traditionally, Data Dictionaries are created manually. This can be a very complex task that leads to the potential loss or misinterpretation of the data. It is very difficult to manually define and dynamically maintain traceability between processes and data, especially for modern complex systems. Dynamic traceability maintained automatically is very useful for the modernization and change of business applications and processes.

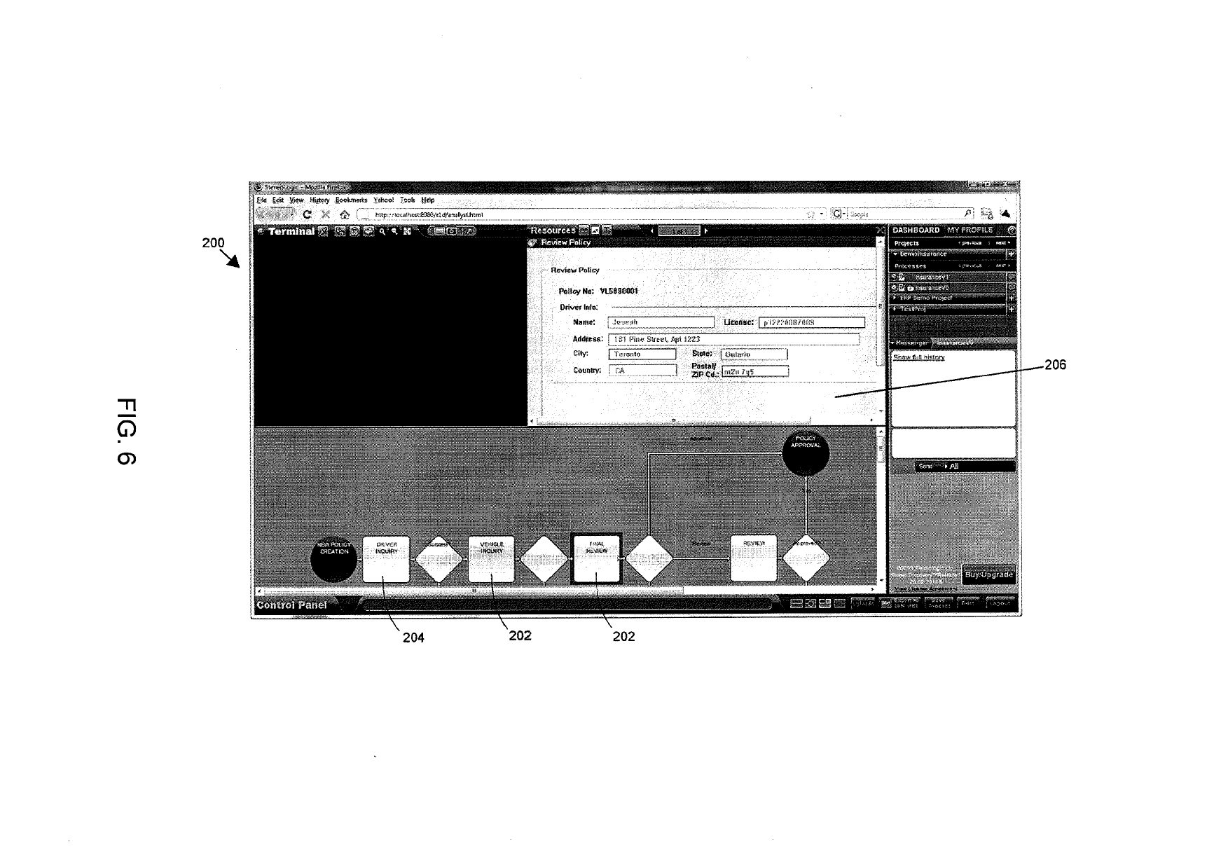

FIG. 6 illustrates an example of a graphical user interface 200 of software implementing Automated Business Process Discovery method. According to this method, and as can be seen in FIG. 6, each activity 202 of the discovered business process 204 is associated with corresponding screens 206 of a business application being analyzed.

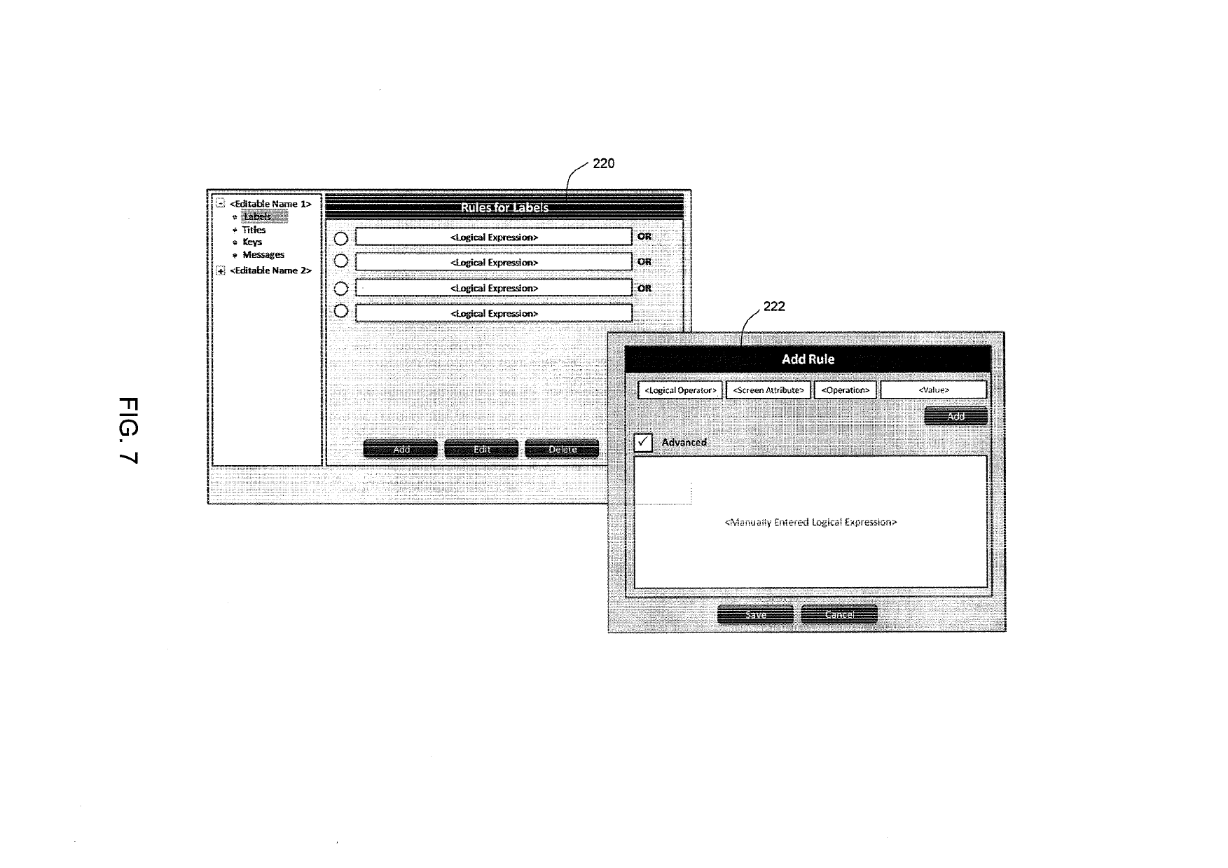

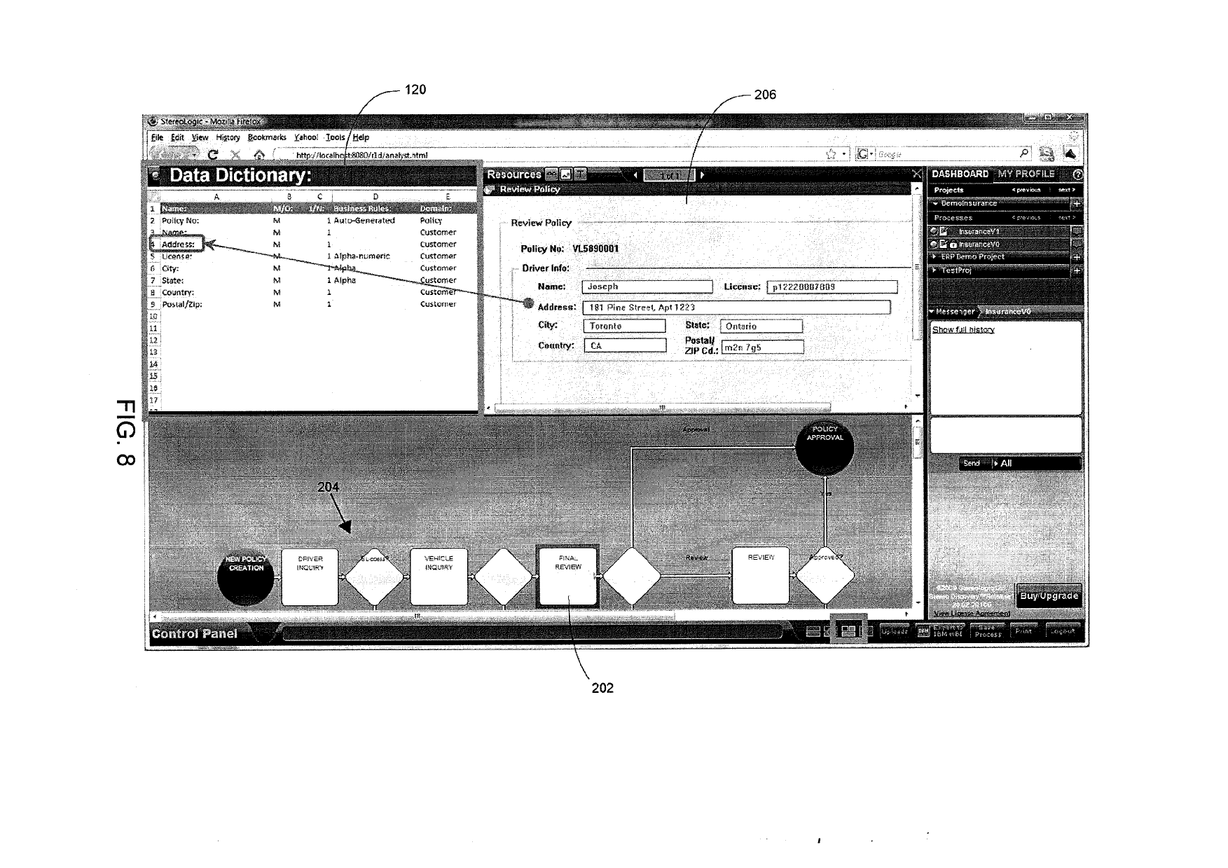

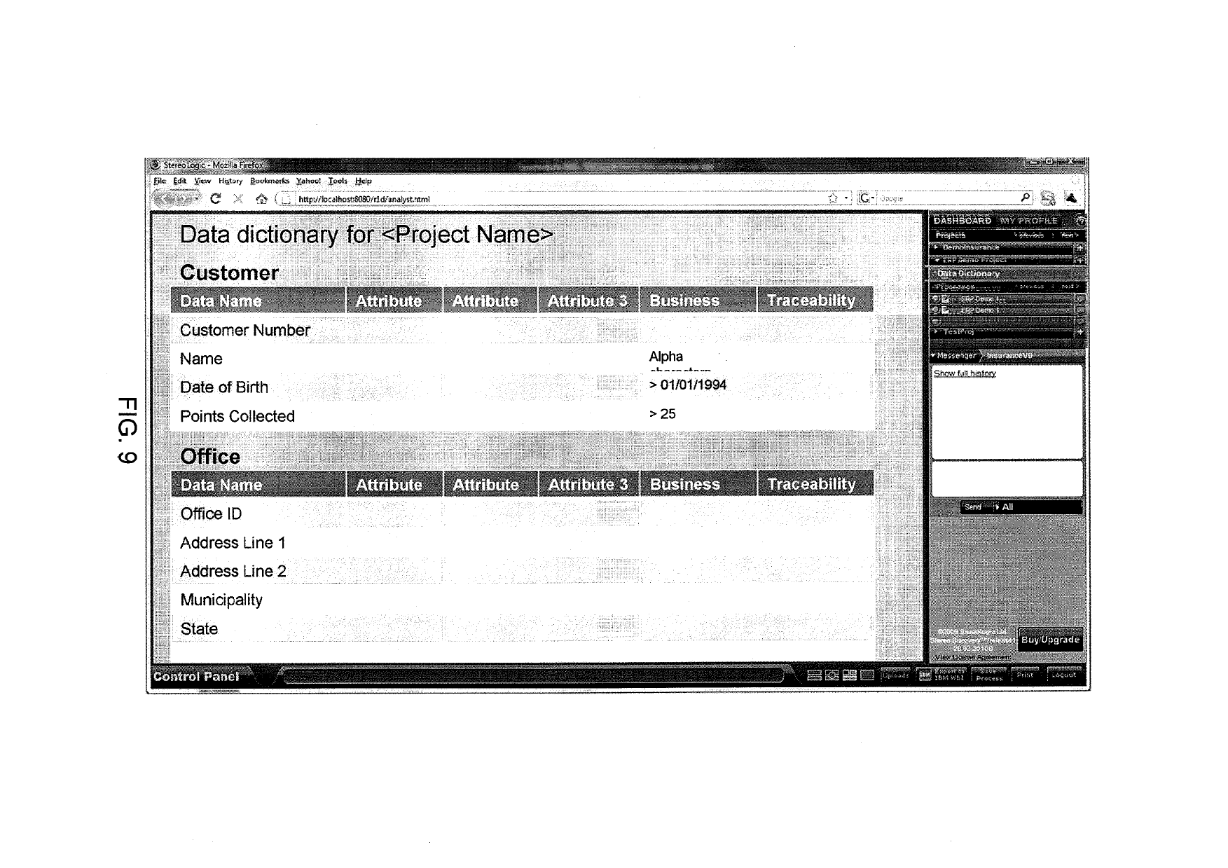

The method of Automated Generation of Data Dictionary and Traceability generally includes:
For each screen associated with a considered activity of discovered business process (BP) define labels or their specific signs such as some attributes by which the labels can be identified. Label identification is shown in FIG. 7. Labels may be viewed, through a user interface 220, with respect to the screen or activity. Labels may be further edited in a rule screen 222.
For each label on the screen, generate corresponding data elements in the Data Dictionary with the same name as the label. As a result of this procedure, a group of data elements will be generated for each screen—“Screen Data” i (where i, is from 1 to N, and N is the number of screens). Data element generation is shown in FIG. 8. The data elements in an activity 202 or as shown in a screen 206 may be entered into a data dictionary 120.
Establish traceability between the considered screen and/or activity and the defined “Screen Data” i.
Analyze all generated data in the data dictionary by merging any two or more identical data elements into one, retaining the traceability with screens and/or activities.
Classify generated data in the data dictionary and define the data attributes based on the required criteria and their physical representation in a database. For example, with reference to FIG. 9: Data group ‘Customer’ includes ‘Customer Name’, read-only. The Customer Name is a classification criterion and ‘read-only’ is an attribute.

The business rules are presented as data attributes in the data dictionary. If some business rule (for example: C>A+B) is related to data elements presented on different screens (A, B, and C belong to different screens), this business rule should be included in all Data Groups where these data elements belong. As a result, business rules may be dynamically traced to BP activities, screens and data.

Any changes in any data, business rules, BP activities and screens will be automatically reflected in all other correlated artefacts via the dynamic traceability established in steps 3 and 4, above.

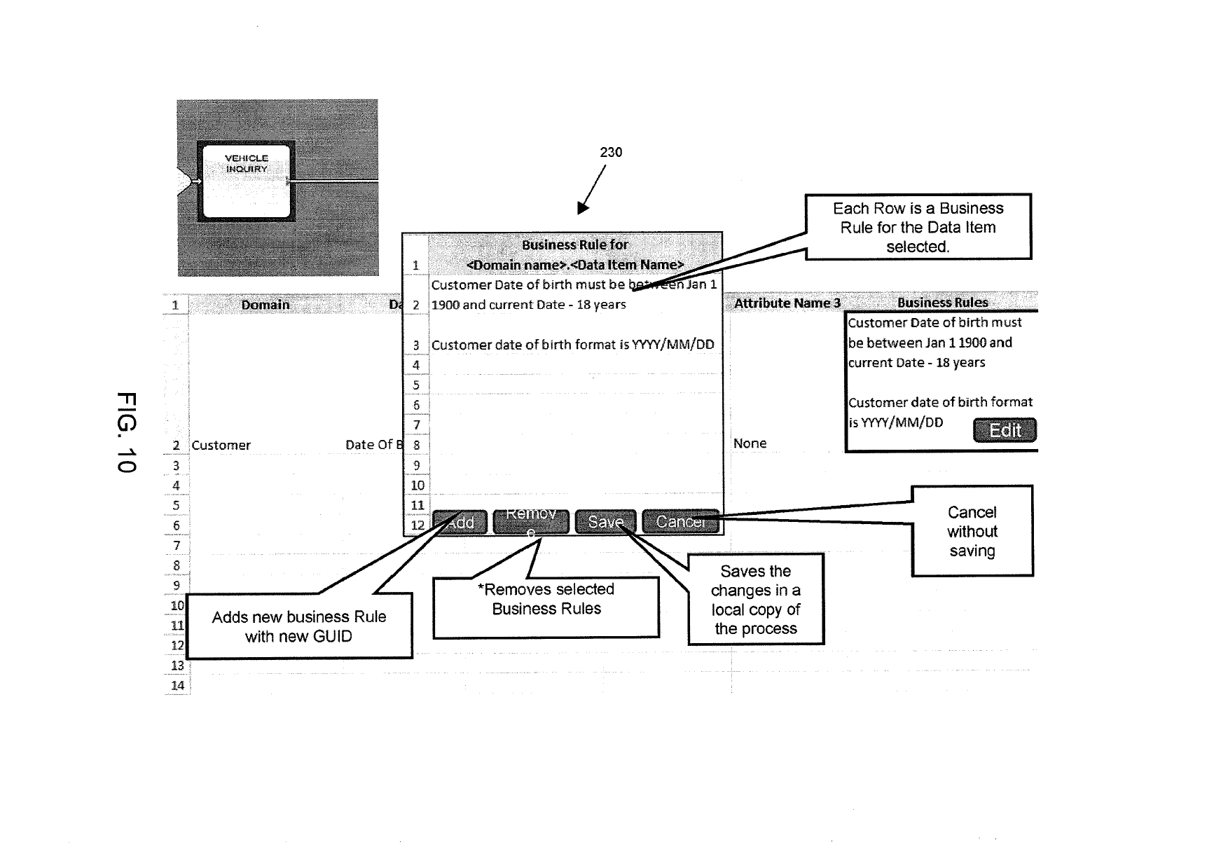

Business rules may be updated in a business rule editor 230 as shown in FIG. 10. A business rule may be updated or modified in the business rule editor 230. Further business rules, for example how a date is shown or requirements with respect to a data element may be included added, removed or saved from the business rule editor 230.

### Platform-Independent Rapid Business Process Discovery

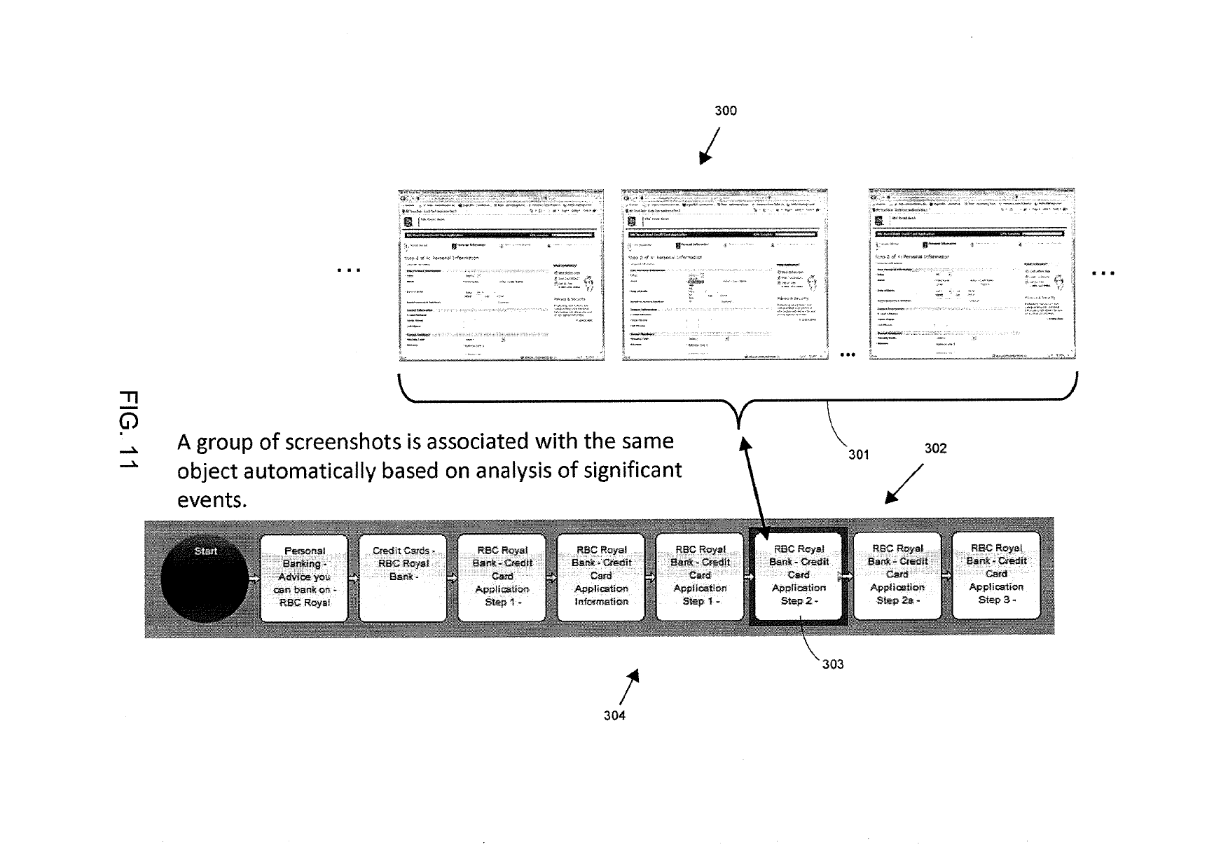

U.S. patent application Ser. No. 12/632,472 described systems and methods for automated business process discovery that were based on system implementation protocols, such as, for example, IBM 3270. The embodiment presented herein and, roughly illustrated in FIG. 11, is intended to provide a broader approach for discovery of business processes running on a variety of platforms or for integrated business processes for a group of applications working on multiple platforms.

The example embodiments described herein allow for the dynamic capture and snapshot of screens from the stream of user-system interaction events. In some cases, the screen snapshots may be done automatically at a predetermined time interval, such as every second or every millisecond. After capture, in either near-realtime or batch processing, the screen snapshots can be analyzed to create business process models and use cases. As shown in FIG. 11, a sequence of captured screens 300 is analyzed for significant events, which indicate particular activities, each of the sets of captured screens 301 is associated with an activity 303 in a sequence of virtual activities 302 of the business process 304 being discovered. Each captured screen 300 is associated with some business process activity 302 in the order of timestamps when these screens were captured. This approach, consequently, provides information about the time required for or at which each business event or combination of activities occurs. The generated business process activities can be visualized and edited in the Business Process Editor.

U.S. patent application Ser. No. 12/632,472 defines a method for recognition of Semantic Screen Elements that allows the extraction of Semantic Elements from each screen snapshot using Image Recognition techniques. The following method is intended to expand on these concepts.

A semi-automated approach for taking screen snapshots typically includes the following:
Using embedded screenshot making tool to create a screenshot reflecting a significant event of the business process flow. This is done, for example, by a push of a button.
The system by default creates a new object representing an event, step, activity and/or use case and associates the screenshot with this object (FIG. 11).
Alternatively the user can associate a new screen with a chosen existing object.
   The system then integrates all existing and created objects into business process flow.

This approach generally requires some manual steps so the business process discovery is not as automatic or dynamic. A dynamic method according to another embodiment herein is intended to allow the discovery of business processes automatically without the need to manual select screenshots. At an automated frequency, the desired screen area is captured by an image capturing module, and resulting image sent to an image repository.

The system includes a mapping module that automatically decides whether to attach the image to an existing object representing an event, step, activity and/or use case object or to create a new object based on, for example, the record mode cursor position (see, for example, U.S. patent application Ser. No. 12/632,472, filed Dec. 7, 2009).

In cases where a new object is created the system connects the new object to the previous elements or objects using the rules of auto-connect (see, for example, U.S. patent application Ser. No. 12/632,472) and moves forward in the business discovery process.

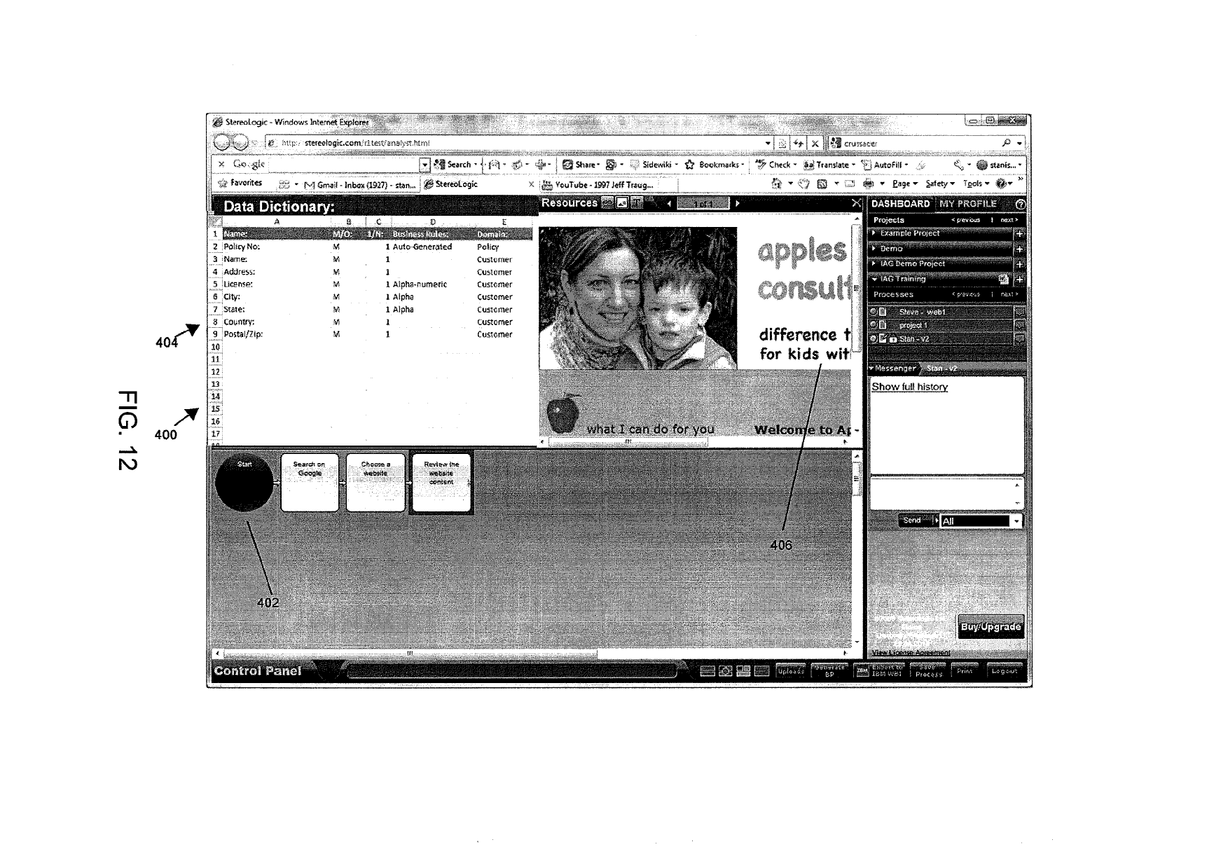

The system automatically attaches the captured image to the object (created or selected) and the image will be available for view immediately upon a users selection of the object. In the example shown in FIG. 12, the business process 402 is shown in one part of the graphical user interface 400. The data dictionary 404 and the captured screen 406 are also shown.

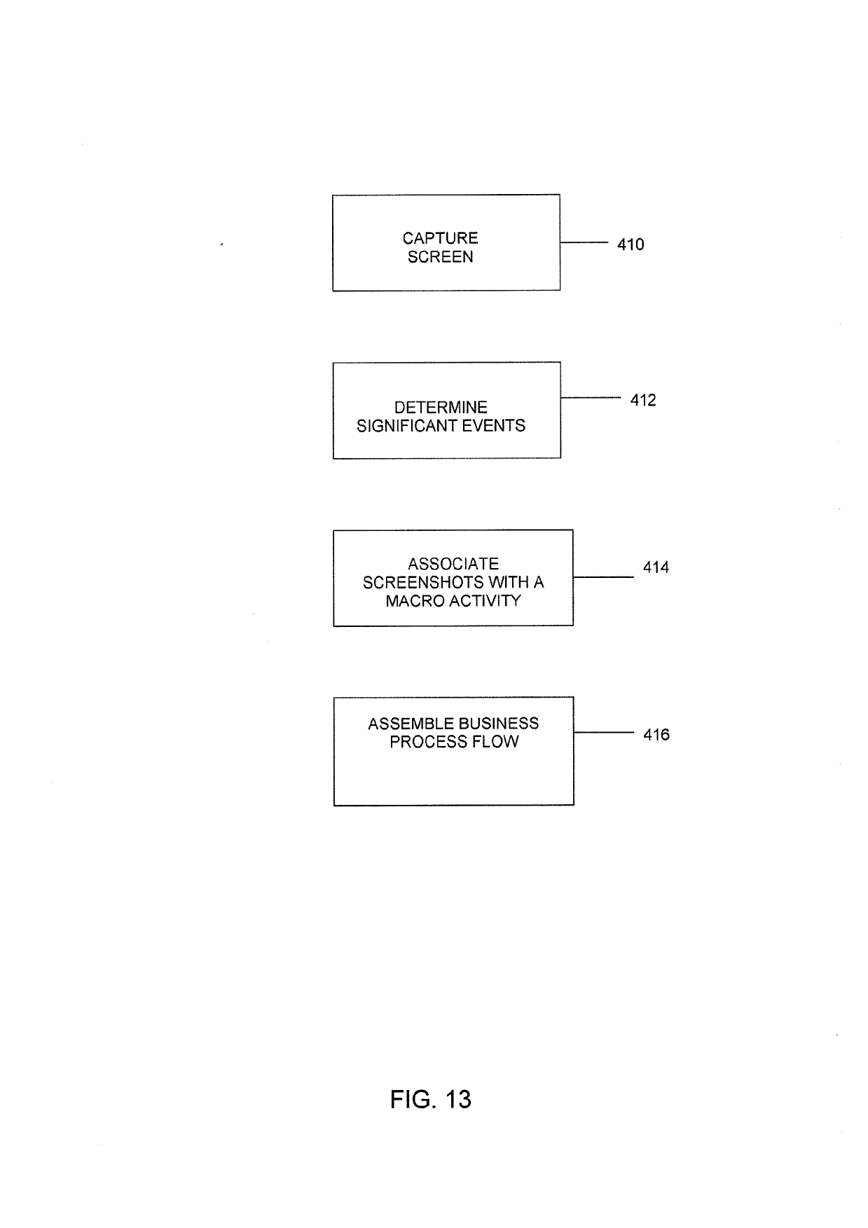

In another example, as shown in the flowchart of FIG. 13, screenshots are captured 410 at a predetermined interval, the method may commence when a user starts working with a business application or may be set to run from login or another appropriate time. The system captures and records screenshots with a preset frequency, for example 1 frame per second. In some cases, the system may focus on an active window while in others it may involve a complete screen shot of the whole screen—either case will sometimes be referred to as a screenshot. In some cases, if the screen (or active window) does not show any changes (all information on the screen remains the same), recording of this screen is not performed.

Recorded screenshots are analyzed to determine significant events. It will be understood that significant events may be different for different types of business applications and appropriate criteria may be set. For example:
For Windows Applications significant events can be determined by change of active window title or any other specified set of window attributes that can be obtained from Windows API.
For Internet Applications the significant events can be determined based a combination of the URL and HTML of considered web pages (see one of the possible methods for Internet Application Discovery described herein).
For Legacy Applications—the significant events may relate to screen changes, changed header information or other information available on the particular platform in use (See U.S. patent application Ser. No. 12/632,472, filed Dec. 7, 2009).

The screenshots captured between two significant events are considered one macro activity within a business process while the individual screenshots can be considered as micro-activities or micro events. The sub-set of screenshots for a macro activity are associated with the macro activity in the business process 414. Macro activities are then assembled into a business process flow 416.

All screenshots associated with a macro activity are saved as micro activities and linked to the macro activity via the association of the subset of screenshots with the macro activity. This linking allows visualization of all of the micro activities, along with their time stamps, for each macro activity in case finer review is required in analyzing the business process.

The use of automated screenshot capture allows each screen to be timestamped. This allows for the calculation and analysis of various performance measurement characteristics. The system determines the performance time for each macro activity as a difference between the time of the first micro activity and time of the last micro activity included in this macro activity. The performance time of the entire business process (or its parts) is determined as a sum of the performance times of all macro activities included in the business process. Therefore the method allows not only discovery of the business processes but also the time it takes to execute the business process. The system may also track the amount of time between activities (either micro or macro) in order to allow analysis of any business process steps that may occur away from a computer screen such as a consultation with a superior or co-worker. These interactions can be determined by flagging periods of time and following-up with the user to determine what occurred during the interval.

In another example, a method for Internet application discovery is provided. The method is intended to increase fidelity of internet application discovery and classify web application flow into discrete business states. Internet application discovery can work on top of existing timed discovery that recognizes active application windows and the associated titles. In this embodiment, an active window is continuously monitored 420 (for example, polled in regular time intervals such as every second or every millisecond). In this particular case, if the window is a browser window and content is a hypertext mark-up language (HTML) top frame or page, the method for Internet application discovery may commence.

The method for internet application discovery calculates a unique identifier or identity of a business state 422 by considering several variables. The variables may include, for example:
Current Page Universal Resource Locator (URL) or parts of it, which may be configurable;
Current Page title; and/or
Structural and Semantic elements of the LIVE HTML DOM tree. The Live tree is intended to allow for the identification of the state and the appearance of structural elements, such as visible/invisible status, color, size, font, etc.

The method for internet application discovery may also create an additional variable by running a script fragment (for example, a JavaScript) against the page identifying VISIBLE elements and the visible elements' attributes that in most cases would determine the business state. Such elements may include
All form and input elements and certain attributes, normally excluding the content or values, although there are certain exceptions when content may be stored;
Text Area, List and Identifiable div elements;
Frame/IFrame and other structural elements; and/or
In certain cases actual content of tags may be included, although frequently actual content may be extraneous.

For each such element a string is computed including the attributes that are considered important for discovery. The strings of the discovered elements are combined into one large string that is then run through, for example, MD5 hash computation, creating a string identifier unique 426 for the discovered state.

Thus discovered information from each web page may include:
Page Title;
Parts of URL;
Identifier String; and
True page dimensions for screenshot taking.

Together, page title, parts of URL and identifier string represent the identity of discovered states. During state classification and business process synthesis states having the same identity can generally be combined. States with different identity will be deemed separate. This classification is intended to increase fidelity of state classification beyond just considering a difference in, for example, title of the screen.

Internet and web pages are loaded from a network and are dynamic due to possible JavaScripts running on them. This possible dynamic state may produce intermediate steps where the page is still loading or is in the middle of changing state due to JavaScript running at the polling moment. To reduce the false discovery of intermediate steps, noise reduction mechanism may be used 424 including, for example:
Page state checking during polling—only pages that have fully completed loading will be discovered, due to Page state check before page analysis.
Identifier String computation via JavaScript fragment that runs in the SAME queue (thread) as all other JavaScript, allowing to minimize half state situations. Computation is run only when other JavaScript is not run. A native agent timeout is implemented if the JavaScript takes too long to run, which may be due to some long JavaScript fragment running on the page before the poll started.

Since the String Identifiers are computed via JavaScript fragment they could be easily modified or automatically regenerated to include or exclude tags from computation. It will be understood that although the example refers to JavaScript, other scripting or other programming languages may be used.

Using the identifiers, significant events can be charted and used to generate macro activities within a business process as outlined above 426.

In some embodiments, some Internet browsers such as Internet Explorer (trademark) may be supported by the software application out of the box, through automation and other API (application programming interfaces). Other browsers could be supported via plugins or automation API.

In the preceding description, for purposes of explanation, numerous details are set forth in order to provide a thorough understanding of the embodiments. However, it will be apparent to one skilled in the art that some of these specific details may not be required. In other instances, well-known structures are sometimes shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope of the disclosure.

We claim:

1. A method for business process modelling of an at least partially computer implemented process, the method comprising:
capturing screenshots of the business process;
analyzing the screenshots to determine significant events;
mapping the significant events to objects in a business process; and
connecting the objects using business rules to model a business process.

2. The method of claim 1 wherein screenshots are captured automatically at a predetermined time interval during the business process.

3. The method of claim 2 wherein screenshots are assigned a timestamp to allow tracking of the time at which events occurred.

4. The method of claim 1 wherein a plurality of screenshots are recorded and a subset of screenshots between significant events is mapped to the same object as at least one of the significant events.

5. The method of claim 1 wherein at least one screenshot is analysed to generate data elements to be saved within a data dictionary.

6. The method of claim 5 wherein data elements in the data dictionary have defined data attributes based on required criteria and the data elements' physical representation.

7. The method of claim 6 wherein business rules related to the data elements in the data dictionary are presented as data attributes.

8. A system for business process modelling comprising:
an image capturing module, configured to capture screenshots of the business process;
an image repository, configured to store the captured screenshots; and
a mapping module, configured to map the captured screenshots to objects and to connect the objects to model a business process.

9. The system of claim 8 further comprising an image analysis module configured to analyse the captured screenshots for significant events and wherein the significant events and associated screenshots are mapped to the objects.
